(19) United States
(12) Patent Application Publication
(10) Pub. No.: US 2013/0062986 A1
(43) Pub. Date: Mar. 14, 2013

(54) ELECTROMAGNETIC COIL, CORELESS ELECTROMECHANICAL DEVICE, MOBILE BODY, ROBOT, AND MANUFACTURING METHOD FOR ELECTROMAGNETIC COIL

(71) Applicant: Kesatoshi TAKEUCHI, Shiojiri (JP)

(72) Inventor: Kesatoshi TAKEUCHI, Shiojiri (JP)

(73) Assignee: SEIKO EPSON CORPORATION, Tokyo (JP)

(21) Appl. No.: 13/605,305

(22) Filed: Sep. 6, 2012

(30) Foreign Application Priority Data
Sep. 9, 2011 (JP) 2011-196716

(51) Int. Cl. H02K 3/28; H01F 41/06

(52) U.S. Cl. 310/208; 29/605

(57) ABSTRACT

An α-wound coil is formed by winding ends on both sides of a predetermined intermediate position of a wire rod from air-core end edges of both the ends toward an outer circumferential side to form two coil portions and superimposing the formed two coil portions to be opposed to each other. When the electromagnetic coil is subjected to bending molding to be adapted to a shape along the cylindrical surface on which the electromagnetic coil is arranged, the circumferential length of a bent-molded shape along the circumferential direction of the cylindrical surface of a first coil portion arranged on the inner circumferential side is set to be smaller than the circumferential length of a bent-molded shape along the circumferential direction of the cylindrical surface of a second coil portion arranged on the outer circumferential side.

### BACKGROUND

1. Technical Field

The present invention relates to an electromagnetic coil suitable for a coreless electromechanical device.

2. Related Art

In a coreless dynamo-electric machine (in this specification, also referred to as “electromechanical device”) such as electric motor or generator, plural air-core electromagnetic coils are arranged along a cylindrical surface in a rotating direction of a rotor. As the electromagnetic coil, for example, an α-wound coil is used. The α-wound coil is a coil configured such that leader wires (also referred to as “lead wires”) at the start of winding and the end of winding of a coil wire rod are placed on the outer side of the coil. The α-wound coil is formed by, for example, superimposing two coil portions, which are formed by symmetrically winding the coil wire rod from the inner side to the outer side such that one end and the other end sides of the coil wire rod are placed on the outer side, to be opposed to each other to be wound in the same direction (see, for example, JP-A-2009-071939).

Since the plural electromagnetic coils used in the electromechanical device are arranged along a curved side surface of a cylinder (also referred to as “cylindrical surface”), a surface along the direction of a wire rod wound from the inner side to the outer side (also referred to as “winding direction”) (also referred to as “winding surface”) is subjected to bending molding to be bent in a curved surface shape along the cylindrical surface. However, when the winding surface of the α-wound coil is subjected to the bending molding to be bent in the curved surface shape, a side surface on the circumferential direction side along the cylindrical surface of a coil portion on the inner circumferential side (also referred to as “circumferential direction side surface”) shifts further to the circumferential direction outer side than a circumferential direction side surface of a coil portion on the outer circumferential side. It is difficult to accurately subject the winding surface to the bending molding. Therefore, in the coreless electromechanical device, it is difficult to accurately arrange the α-wound coil subjected to the bending molding to be laid along the cylindrical surface. As a result, a loss of efficiency of the coreless electromechanical device is caused. However, this problem hardly occurs when, in each of the coil portions, the number of layers of winding (also referred to as “winding layers”) in a direction perpendicular to the direction along the winding surface (the winding direction) (also referred to as “winding thickness direction”) is one or, even if there are plural winding layers, the number of winding layers is small and the thickness in the winding thickness direction (also referred to as “winding thickness”) is small. However, when the number of winding layers is large and the winding thickness is large, the problem is conspicuous.

FIG. 17 is an explanatory diagram showing a problem that occurs when the α-wound coil is subjected to the bending molding. A diagram on the left side shows a winding surface of an α-coil 100α viewed from the upper side. A diagram on the right side shows a side surface of the α-coil 100α viewed from the right side. As the winding thickness of coil portions 100αa and 100αb increases, a difference in appropriate winding width along a curved surface after molding is more likely to occur between the inner circumferential side and the outer circumferential side. Specifically, appropriate winding width is smaller further on the inner circumferential side. After forming of the α-coil 100α shown in FIG. 17, in the coil portion 100αa on the inner circumferential side, winding width Wo before the bending molding desirably changes to winding width Wi (<Wo) obtained by compression-deforming the coil portion 100αa according to a curvature. However, a superimposed surface of the coil portion 100αa on the inner circumferential side and the coil portion 100αb on the outer circumferential side is simply a superimposed structure. Therefore, the circumferential side surface of the coil portion 100αa on the inner circumferential side shifts to the outer side along the circumferential direction from a surface including the circumferential side surface of the coil portion 100αb on the outer circumferential side (a surface along the center axis of a cylinder and a radiation direction perpendicular to the center axis, also referred to as “radiation surface”) because of the compression molding. An amount of the shift becomes more conspicuous as the winding thickness increases.

### SUMMARY

An advantage of some aspects of the invention is to provide an electromagnetic coil that can be accurately and easily subjected to bending molding and is suitable for a coreless electromechanical device and provide an efficient coreless electromechanical device to which the electromagnetic coil is applied.

### Application Example 1

This application example of the invention is directed to an electromagnetic coil being an air-core electromagnetic coil arranged along a cylindrical surface of a first member or a second member having a cylindrical shape in a coreless electromechanical device in which the first member and the second member relatively rotate, the electromagnetic coil being an α-wound coil formed by winding ends on both sides of a predetermined intermediate position of a wire rod from air-core end edges of both the ends toward the outer circumferential side to form two coil portions and superimposing the formed two coil portions to be opposed to each other, wherein when the electromagnetic coil is subjected to bending molding to be adapted to a shape along the cylindrical surface on which the electromagnetic coil is arranged, the width before the bending molding along the circumferential direction of the cylindrical surface of a first coil portion arranged on the inner circumferential side is set to be smaller than the width before the bending molding along the circumferential direction of the cylindrical surface of a second coil portion arranged on the outer circumferential side.

When the electromagnetic coil is subjected to the bending molding to be adapted to the shape along the cylindrical surface on which the electromagnetic coil is arranged in the coreless electromechanical device, a side surface on the circumferential direction side along a cylindrical surface of the first coil portion arranged on the inner circumferential side shifts to the outer side in the circumferential direction and can be formed as the same plane as a side surface on the circumferential direction side of the second coil portion arranged on the outer circumferential side. Therefore, it is possible to perform accurate and easy bending molding. Consequently, it is possible to provide an electromagnetic coil suitable for the coreless electromechanical device.

### Application Example 2

This application example of the invention is directed to the electromagnetic coil of Application Example 1, wherein the thickness of the second coil portion along a superimposing direction of the two coil portions is smaller than the thickness of the first coil portion.

As the position of the superimposition of the two coil portions is further on the inner circumferential side with respect to the outermost circumferential side, i.e., as the thickness of the first coil portion along the superimposing direction is larger, the shift of the first coil portion is larger. Therefore, if the thickness of the second coil portion is smaller than the thickness of the first coil portion, it is possible to reduce the shift and perform accurate and easy bending molding.

### Application Example 3

This application example of the invention is directed to the electromagnetic coil of Application Example 1 or 2, wherein the first coil portion is divided into a plurality of first coil regions along the superimposing direction of the two coil portions, and the width before the bending molding along the circumferential direction of the cylindrical surface of the first coil regions decreases in order further away from a superimposed surface of the two coil portions.

With the electromagnetic coil, in the first coil portion, it is possible to change the width of the first coil regions. Therefore, it is possible to more accurately and easily perform the bending molding.

### Application Example 4

This application example of the invention is directed to the electromagnetic coil of Application Example 3, wherein the second coil portion is divided into a plurality of second coil regions along the superimposing direction, and the width before the bending molding along the circumferential direction of the cylindrical surface of the second coil regions increases in order further away from a superimposed surface of the two coil portions.

With the electromagnetic coil, in the second coil portion, it is possible to change the width of the second coil regions. Therefore, it is possible to more accurately and easily perform the bending molding.

### Application Example 5

This application example of the invention is directed to a coreless electromechanical device in which first and second members having a cylindrical shape relatively rotate, the coreless electromechanical device including: a permanent magnet arranged in the first member; and a plurality of air-core electromagnetic coils arranged in the second member, wherein the electromagnetic coil is the electromagnetic coil of any one of Application Examples 1 to 4.

Since the coreless electromechanical device includes the electromagnetic coil described above, it is possible to accurately arrange the electromagnetic coils along the cylindrical surface and accurately form an electromagnetic field by the electromagnetic coils. Therefore, it is possible to improve efficiency of the coreless electromechanical device.

### Application Example 6

This application example of the invention is directed to a mobile body including the coreless electromechanical device of Application Example 5.

### Application Example 7

This application example of the invention is directed to a robot including the coreless electromechanical device of Application Example 5.

### Application Example 8

This application example of the invention is directed to a method of manufacturing an air-core electromagnetic coil arranged along a cylindrical surface of a first member or a second member having a cylindrical shape in a coreless electromechanical device in which the first member and the second member relatively rotate, the method including: winding ends on both sides of a predetermined intermediate position of a wire rod from air-core end edges of both the ends toward the outer circumferential side to form two coil portions, when the electromagnetic coil is subjected to bending molding to be adapted to a shape along the cylindrical surface on which the electromagnetic coil is arranged in the coreless electromechanical device, the width before the bending molding along the circumferential direction of the cylindrical surface of a first coil portion arranged on the inner circumferential side being set to be smaller than the width before the bending molding along the circumferential direction of the cylindrical surface of a second coil portion arranged on the outer circumferential side; superimposing the formed two coil portions to be opposed to each other; and subjecting the superimposed two coil portions to the bending molding to be adapted to the shape along the cylindrical surface on which the electromagnetic coil is arranged in the coreless electromechanical device.

With the method, it is possible to easily manufacture an air-core electromagnetic coil suitable for the coreless electromechanical device.

The invention can be implemented in various forms. For example, besides the electromagnetic coil and the method of manufacturing the electromagnetic coil, it is possible to implement the invention in various forms including a coreless electromechanical device such as an electric motor or a generator including the electromagnetic coil and a mobile body, a robot, or a medical apparatus including the coreless electromechanical device.

### BRIEF DESCRIPTION OF THE DRAWINGS

The invention will be described with reference to the accompanying drawings, wherein like numbers reference like elements.

FIGS. 1A and 1B are explanatory diagrams showing a coreless motor according to a first embodiment.

FIGS. 2A to 2C are explanatory diagrams schematically showing a cross section of the coreless motor according to the first embodiment taken along a cutting line perpendicular to a rotating shaft.

FIGS. 3A and 3B are explanatory diagrams showing an arrangement state of electromagnetic coils in the coreless motor according to the first embodiment.

FIGS. 4A to 4C are explanatory diagrams showing a process for forming the electromagnetic coil.

FIGS. 5A and 5B are explanatory diagrams showing the process for forming the electromagnetic coil.

FIGS. 6A and 6B are explanatory diagrams showing the process for forming the electromagnetic coil.

FIG. 7 is an explanatory diagram showing a modification of the electromagnetic coil.

FIGS. 8A and 8B are explanatory diagrams showing a coreless motor according to a second embodiment.

FIG. 9 is an explanatory diagram showing an arrangement state of electromagnetic coils in the coreless motor according to the second embodiment.

FIGS. 10A and 10B are explanatory diagrams showing a coreless motor according to a third embodiment.

FIGS. 11A and 11B are explanatory diagrams showing a coreless motor according to a fourth embodiment.

FIGS. 12A and 12B are explanatory diagrams showing a coreless moor according to a fifth embodiment.

FIG. 13 is an explanatory diagram showing an electric bicycle (an electrically assisted bicycle), which is an example of a mobile body in which a coreless motor having a configuration of the invention is used.

FIG. 14 is an explanatory diagram showing an example of a robot in which a coreless motor having a configuration of the invention is used.

FIG. 15 is an explanatory diagram showing an example of a double-arm 7-axis robot in which a coreless motor having a configuration of the invention is used.

FIG. 16 is an explanatory diagram showing a railway vehicle in which a coreless motor having a configuration of the invention is used.

FIG. 17 is an explanatory diagram showing a problem that occurs when an α-wound coil is subjected to bending molding.

### DESCRIPTION OF EXEMPLARY EMBODIMENTS

### First Embodiment

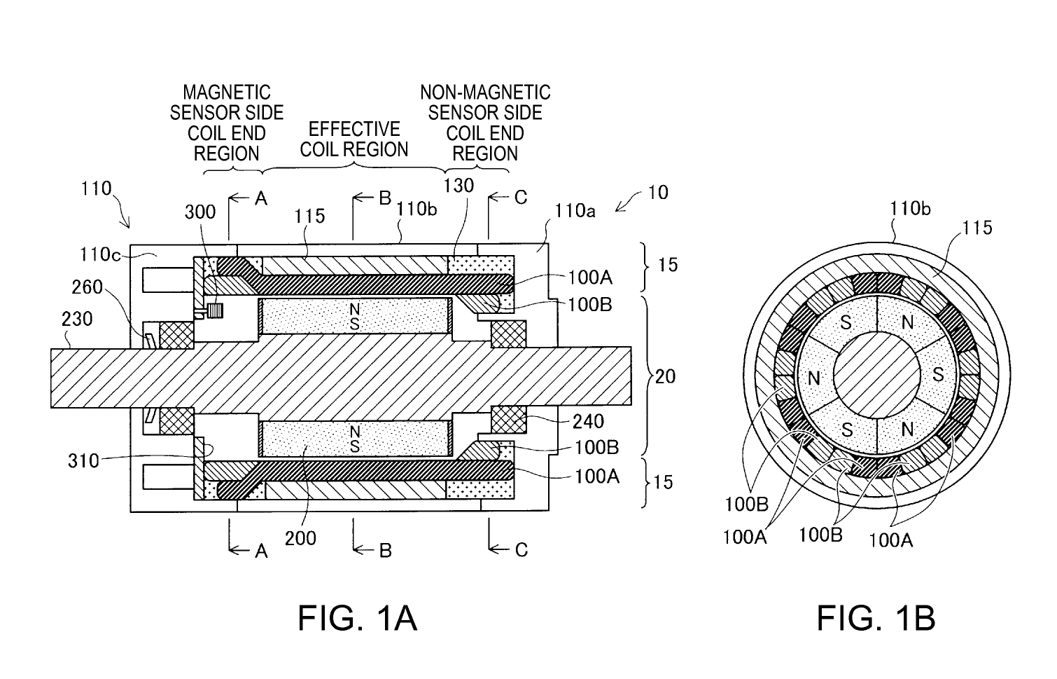

FIGS. 1A and 1B are explanatory diagrams showing a coreless motor 10 according to a first embodiment. FIG. 1A schematically shows a diagram of a schematic cross section of the coreless motor 10 taken along a surface parallel to a rotating shaft 230 and viewed from a direction perpendicular to the cross section. FIG. 1B schematically shows a diagram of a schematic cross section of the coreless motor 10 taken along a cutting line (B-B in FIG. 1A) perpendicular to the rotating shaft 230 and viewed from a direction perpendicular to the cross section.

The coreless motor 10 is an inner rotor type motor having a radial gap structure in which a substantially cylindrical stator 15 is arranged on the outer side and a substantially cylindrical rotor 20 is arranged on the inner side. The stator 15 includes a coil back yoke 115 arranged along the inner circumference of a substantially cylindrical casing portion 110b of a casing 110 and plural electromagnetic coils 100A and 100B arrayed on the inner side of the coil back yoke 115. In this embodiment, when the two-phase electromagnetic coils 100A and 100B are not distinguished, the electromagnetic coils 100A and 100B are simply referred to as electromagnetic coils 100. The coil back yoke 115 is formed of a magnetic material and formed in a substantially cylindrical shape. The electromagnetic coils 100A and 100B are molded with resin 130.

The length of the electromagnetic coils 100A and 100B along the rotating shaft 230 is larger than the length of the coil back yoke 115 along the rotating shaft 230. In other words, in FIG. 1A, ends in the left right direction of the electromagnetic coils 100A and 100B do not overlap the coil back yoke 115. In this embodiment, regions overlapping the coil back yoke 115 are referred to as effective coil regions. Regions not overlapping the coil back yoke 115 are referred to as coil end regions. In this embodiment, the effective coil regions of the electromagnetic coils 100A and 100B are arranged in a cylindrical region along the same cylindrical surface. However, concerning the coil end regions, as explained below, one of two coil end regions is bent from the cylindrical region to the outer circumferential side or the inner circumferential side. For example, concerning the electromagnetic coil 100A, as shown in FIG. 1A, the coil end region on the right side is arranged in the cylindrical region and is not bent. However, the coil end region on the left side is bent from the cylindrical region to the outer circumferential side. Concerning the electromagnetic coil 100B, as shown in FIG. 1A, the coil end region on the left side is arranged in the cylindrical region and is not bent. However, the coil end region on the right side is bent from the cylindrical region to the inner circumferential side. The electromagnetic coils 100A and 100B may have structure in which the shapes of the coil end regions thereof are interchanged.

Further, in the stator 15, a magnetic sensor 300 functioning as a position sensor that detects the phase of the rotor 20 is arranged. As the magnetic sensor 300, for example, a Hall sensor configured by a Hall IC including a Hall element can be used. The magnetic sensor 300 generates a substantially sine-wave sensor signal according to driving control of an electric angle. The sensor signal is used for generating a driving signal for driving the electromagnetic coil 100. Therefore, one magnetic sensor 300 is desirably provided in each of the two-phase electromagnetic coils 100A and 100B. The magnetic sensor 300 is fixed on a circuit board 310. The circuit board 310 is fixed to a casing portion 110c of the casing 110. In this embodiment, the magnetic sensor 300 and the circuit board 310 are arranged on the left side of FIG. 1A. In this embodiment, using a positional relation between the magnetic sensor 300 and the coil end regions, the coil end region close to the magnetic sensor 300 (the coil end region on the left side of FIG. 1A) of the two coil end regions is referred to as “magnetic sensor side coil end region” and the coil end region far from the magnetic sensor 300 (the coil end region on the right side of FIG. 1A) is referred to as “non-magnetic sensor side coil end region”.

The rotor 20 includes the rotating shaft 230 in the center and includes plural permanent magnets 200 around the rotating shaft 230. The permanent magnets 200 are magnetized along a radial direction (a radiation direction) from the center of the rotating shaft 230 to the outside. The characters N and S affixed to the permanent magnets 200 in FIG. 1B indicate the polarities of the permanent magnets 200 on the electromagnetic coils 100A and 100B side. The permanent magnets 200 and the electromagnetic coils 100 are arranged to be opposed to opposed cylindrical surfaces of the rotor 20 and the stator 15. The length of the permanent magnet 200 in the direction along the rotating shaft 230 is the same as the length of the coil back yoke 115 in the direction along the rotating shaft 230. In other words, regions where the permanent magnet 200, a region between the coil back yoke 115 and the electromagnetic coil 100A or the electromagnetic coil 100B overlap are the effective coil regions. The rotating shaft 230 is supported by a bearing 240 of the casing 110. A magnet back yoke may be provided between the permanent magnet 200 and the rotating shaft 230. Side yokes may be provided at both ends of the permanent magnet 200 in the direction along the rotating shaft 230. A magnetic flux can be easily closed by using the magnet back yoke or the side yokes. In this embodiment, a wave spring metal washer 260 is provided on the inner side of the casing 110. The wave spring metal washer 260 positions the permanent magnet 200. However, the wave spring metal washer 260 can be replaced with another component.

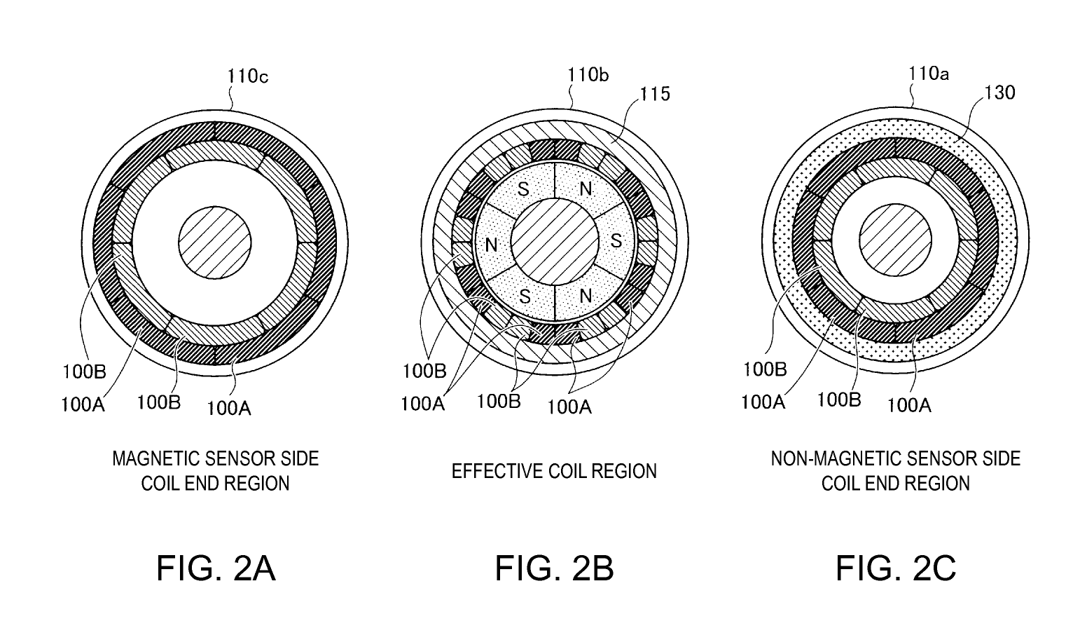

FIGS. 2A to 2C are explanatory diagrams schematically showing a cross section of the coreless motor 10 according to the first embodiment taken along a cutting line perpendicular to the rotating shaft 230. FIG. 2A shows a schematic cross section of the magnetic sensor side coil end region of the electromagnetic coils 100A and 100B taken along an A-A cutting line perpendicular to the rotating shaft 230 shown in FIG. 1A. FIG. 2B shows a schematic cross section of the effective coil region of the electromagnetic coils 100A and 100B taken along a B-B cutting line perpendicular to the rotating shaft 230 shown in FIG. 1A. FIG. 2C shows a schematic cross section of the non-magnetic sensor side coil end region of the electromagnetic coils 100A and 100B taken along a C-C cutting line perpendicular to the rotating shaft 230 shown in FIG. 1A. FIG. 2B is a drawing same as FIG. 1B.

As shown in FIG. 2B, in the cross section perpendicular to the rotating shaft 230 in the effective coil regions of the electromagnetic coils 100A and 100B (the cross section taken along the B-B cutting line in FIG. 1A), the effective coil regions of the electromagnetic coils 100A and 100B are arranged in the same cylindrical region. On the other hand, in the cross section perpendicular to the rotating shaft 230 in the magnetic sensor side coil end region shown in FIG. 2A, the coil end region of the electromagnetic coil 100B is arranged in the cylindrical region same as the cylindrical region where the effective coil region of the electromagnetic coil 100B is arranged in FIG. 2B. However, the coil end region of the electromagnetic coil 100A is arranged further on the outer circumferential side (the coil back yoke 115 side) than the cylindrical region where the effective coil region of the electromagnetic coil 100A is arranged. In the cross section perpendicular to the rotating shaft 230 in the non-magnetic sensor side coil end region shown in FIG. 2C, the coil end region of the electromagnetic coil 100A is arranged in the cylindrical region same as the cylindrical region where the effective coil region of the electromagnetic coil 100A is arranged in FIG. 2B. However, the coil end region of the electromagnetic coil 100B is arranged further on the inner circumferential side (the permanent magnet 200 side) than the cylindrical region where the effective coil region of the electromagnetic coil 100B is arranged.

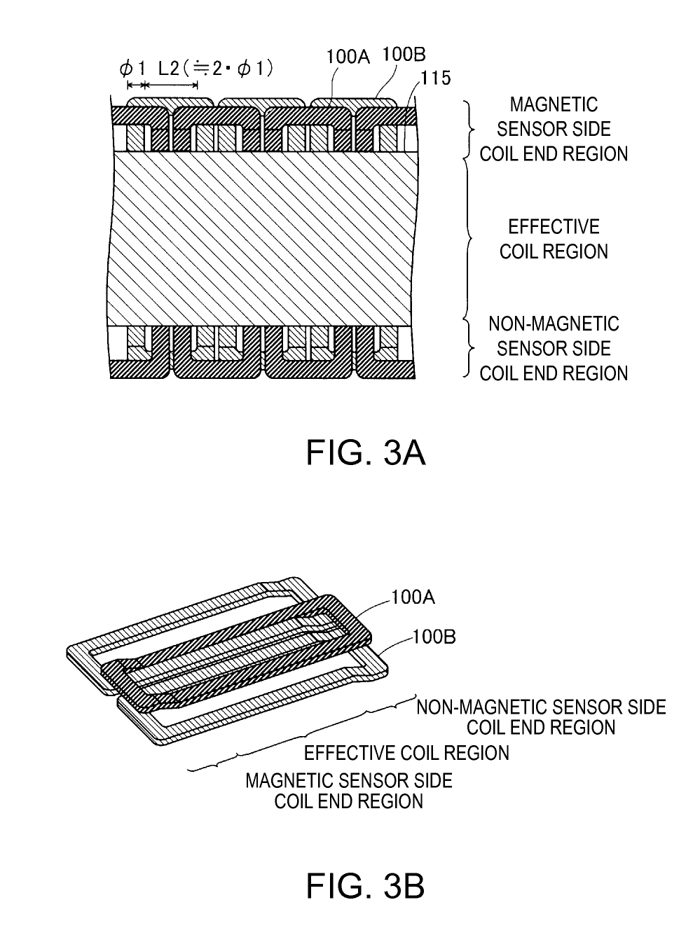

FIGS. 3A and 3B are explanatory diagrams showing an arrangement state of the electromagnetic coils 100A and 100B. FIG. 3A is a plan view of the electromagnetic coils 100A and 100B viewed from the coil back yoke side. FIG. 3B is a perspective view schematically showing the electromagnetic coils 100A and 100B. In FIG. 3A, the coil back yoke 115 is shown. In FIG. 3B, to clearly show the shapes of the electromagnetic coils 100A and 100B, the coil back yoke 115 is not shown and only one electromagnetic coil 100A and two electromagnetic coils 100B are shown. Actual electromagnetic coils 100A and 100B are arranged along a side surface of a cylinder. However, in FIG. 3B, the electromagnetic coils 100A and 100B are schematically shown as a plane.

Bundles of conductors in the effective coil region of the two electromagnetic coils 100B are fit in between two bundles of conductors of the effective coil region of the electromagnetic coil 100A. The electromagnetic coils 100 are formed by winding conductors in plural turns. A bundle of conductors (hereinafter also referred to as “coil bundle”) means a bundle of plural conductors. Coil bundles in the effective coil region of the two electromagnetic coils 100A are fit in between two coil bundles in the effective coil region of the electromagnetic coil 100B. The electromagnetic coil 100A and the electromagnetic coil 100B do not interfere with each other. The magnetic sensor side coil end region of the electromagnetic coil 100A is bent from the cylindrical region to the coil back yoke 115 side (the outer circumferential side of the cylindrical region). The magnetic sensor side coil end region of the electromagnetic coil 100A does not interfere with the magnetic sensor side coil end region of the electromagnetic coil 100B. The non-magnetic sensor side coil end region of the electromagnetic coil 100B is bent from the cylindrical region to the opposite side of the coil back yoke 115 (the inner circumferential side of the cylindrical region). The non-magnetic sensor side coil end region of the electromagnetic coil 100B does not interfere with the non-magnetic sensor side coil end region of the electromagnetic coil 100A. In this way, the effective coil region of the electromagnetic coil 100A and the effective coil region of the electromagnetic coil 100B are arranged not to interfere with each other on the same cylindrical region. The magnetic sensor side coil end region of the electromagnetic coil 100A is bent to the outer circumferential side and the non-magnetic sensor side coil end region of the electromagnetic coil 100B is bent to the inner circumferential side. Consequently, it is possible to suppress interference of the electromagnetic coil 100A and the electromagnetic coil 100B.

In this embodiment, thickness φ1 of the coil bundles of the electromagnetic coils 100A and 100B (thickness in a direction along the cylindrical region where the effective coil region of the electromagnetic coil 100A is arranged) and a space L2 of the coil bundles in the effective coil region (a space in the direction along the cylindrical region where the effective coil region of the electromagnetic coil 100A is arranged) have a relation L2≡2×φ1. In other words, the cylindrical region where the electromagnetic coils 100A and 100B are arranged is nearly occupied by the coil bundles of the electromagnetic coils 100A and 100B. Therefore, it is possible to improve a space factor of the electromagnetic coils and improve efficiency of the coreless motor 10 (FIG. 1A).

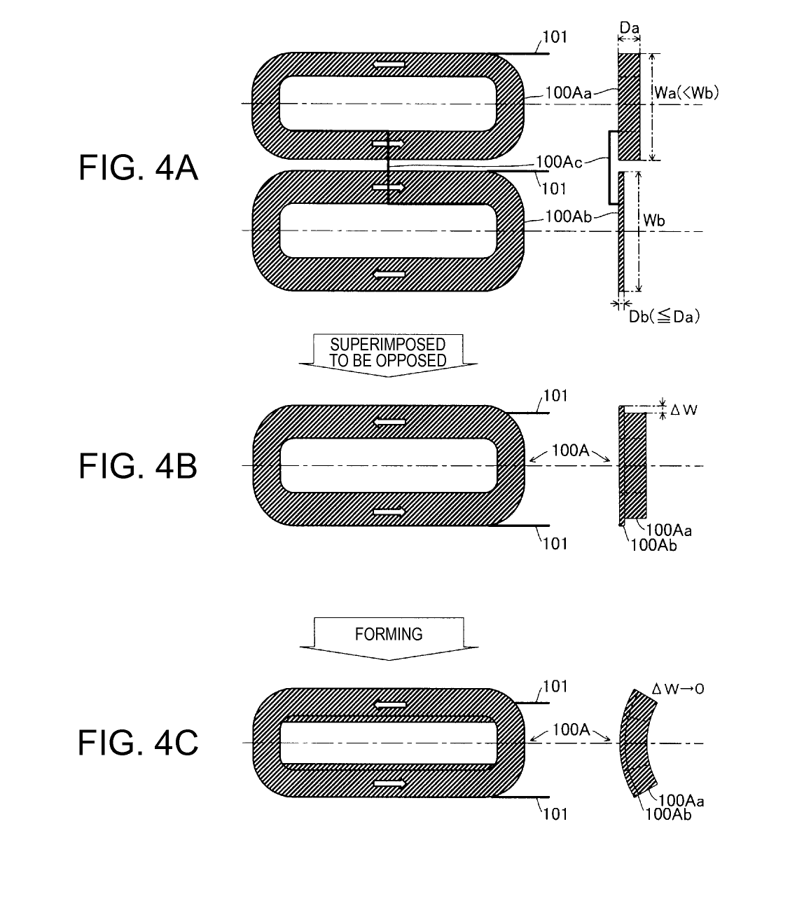

FIGS. 4A to 4C are explanatory diagrams showing a process for forming the electromagnetic coil. Before the coil end regions is bent from the cylindrical region where the effective coil regions of the electromagnetic coils 100A and 100B are arranged to the outer circumferential side or the inner circumference side, the electromagnetic coils 100A and 100B can be formed in the same process. Therefore, the electromagnetic coil 100A is explained as an example. First, in a step shown in FIG. 4A, an electromagnetic coil wire rod 101 is prepared. Ends on both sides of a predetermined intermediate position of the electromagnetic coil wire rod 101 are wound from air-core end edges of the ends to the outer circumferential side to be α-wound to form two coil portions 100Aa and 100Ab from one electromagnetic coil wire rod 101. One coil portion 100Aa is formed by winding the electromagnetic coil wire rod 101 in a winding width direction and a winding thickness direction to have winding width Wa and winding thickness Da. On the other hand, the other coil portion 100Ab is formed by winding the electromagnetic coil wire rod 101 in the winding width direction and the winding thickness direction to have winding width Wb larger than the winding width Wa and winding thickness Db smaller than the winding thickness Da. The winding widths Wa and Wb are equivalent to width before bending molding along the circumferential direction of a cylindrical surface in the invention. Differences between the winding widths and the winding thicknesses of the two coil portions 100Aa and 100Ab are explained below.

Innermost circumferential end edges (winding starts) of the two coil portions 100Aa and 100Ab along the outer circumferential end edges of air-cores thereof are connected to each other by a connecting section 100Ac. The length of the connecting section 100Ac is desirably set to length at which the connecting section 100Ac is arranged along the inner circumference of the coil portion 100Aa when the coil portions 100Aa and 100Ab are superimposed. Specific length of the connecting section 100Ac is different depending on drawing-out positions of the connecting section 100Ac in the two coil portions 100Aa and 100Ab. For example, in an example shown in FIG. 4A, the length is integer times as long as the length of the inner circumference of the coil portion 100Aa or the coil portion 100Ab. The length of the connecting section 100Ac may be set to length that does not cause extra length when the coil portions 100Aa and 100Ab are superimposed.

Subsequently, in a step shown in FIG. 4B, the electromagnetic coil 100A is formed by superimposing the two coil portions 100Aa and 100Ab to be opposed to each other such that the winding directions of the two coil portions 100Aa and 100Ab coincide with each other and the outer circumferential edge of one coil portion 100Ab is further on the outer side by a difference ΔW (≡[Wb−Wa]/2) than the outer circumferential edge of the other coil portion 100Aa. At this point, since the connecting section 100Ac is left over, the connecting section 100Ac is drawn around along the inner circumference of the coil portion 100Aa or the coil portion 100Ab.

In a step shown in FIG. 4C, forming (bending molding) for bending the electromagnetic coil 100A along the cylindrical region is executed. At this point, as explained concerning the problem in the past, the outer edge in the circumferential direction side (the side surface on the circumferential direction side) of the cylinder of the coil portion 100Aa on the inner circumferential side of the cylinder of the electromagnetic coil 100A subjected to the forming shifts to the outer side along the circumferential direction of the cylinder with respect to the outer edge (the side surface on the circumferential direction side) of the coil portion 100Ab on the outer circumferential side.

Therefore, in this embodiment, as shown in FIG. 4A, the winding width Wa of the coil portion 100Aa before the forming is set smaller than the winding width Wb of the coil portion 100Ab. At this point, it is desirable to set the winding width Wb of the coil portion 100Ab and the winding width Wa of the coil portion 100Aa such that the outer edge on the circumferential direction side (the side surface on the circumferential direction side) of the cylinder of the coil portion 100Ab on the outer circumferential side of the cylinder and the outer edge on the circumferential direction side (the side surface on the circumferential direction side) of the cylinder of the coil portion 100Aa on the inner circumferential side of the cylinder form substantially the same planes during the forming. In this way, the outer edge on the circumferential direction side (the side surface on the circumferential direction side) of the cylinder of the coil portion 100Ab on the outer circumferential side of the cylinder and the outer edge on the circumferential direction side (the side surface on the circumferential direction side) of the cylinder of the coil portion 100Aa on the inner circumferential side of the cylinder can form substantially the same planes (radiation surfaces) during the forming. Consequently, it is possible to subject the electromagnetic coils 100A and 100B to the bending molding to be accurately adapted to the shape along the cylindrical surface and accurately arrange the electromagnetic coils 100A and 100B along the cylindrical surface.

The winding thickness Db of the coil portion 100Ab on the outer circumferential side of the cylinder during the forming is set small and the winding thickness Da of the coil portion 100Aa on the inner circumferential side of the cylinder is set large to be Da>Db. This is because, as explained above, since a relative shift amount increases as the winding thickness of the two coil portions 100Aa and 100Ab increases and the superimposed surface is further on the inner circumferential side of the cylinder, it is desirable to set the winding thickness Db of the coil portion 100Aa on the outer circumferential side small in order to reduce a difference between the winding width Wa of the coil portion 100Aa on the outer circumferential side and the winding width Wb of the coil portion 100Ab on the inner circumferential side. However, this is not always a limitation. The winding thicknesses Da and Db of the two coil portions 100Aa and 100Ab may be set the same. In this case, there is an advantage that, if total thicknesses of the coil portions are the same, it is possible to reduce time for forming the respective coil portions. The winding thickness Db of the coil portion 100Aa on the outer circumferential side may be set large and the winding thickness Da of the coil portion 100Ab on the inner circumferential side may be set small to be Da<Db. However, in this case, since the relative shift amount increases, it is highly necessary to increase the difference ΔW between the winding thicknesses according to the increase in the relative shift amount.

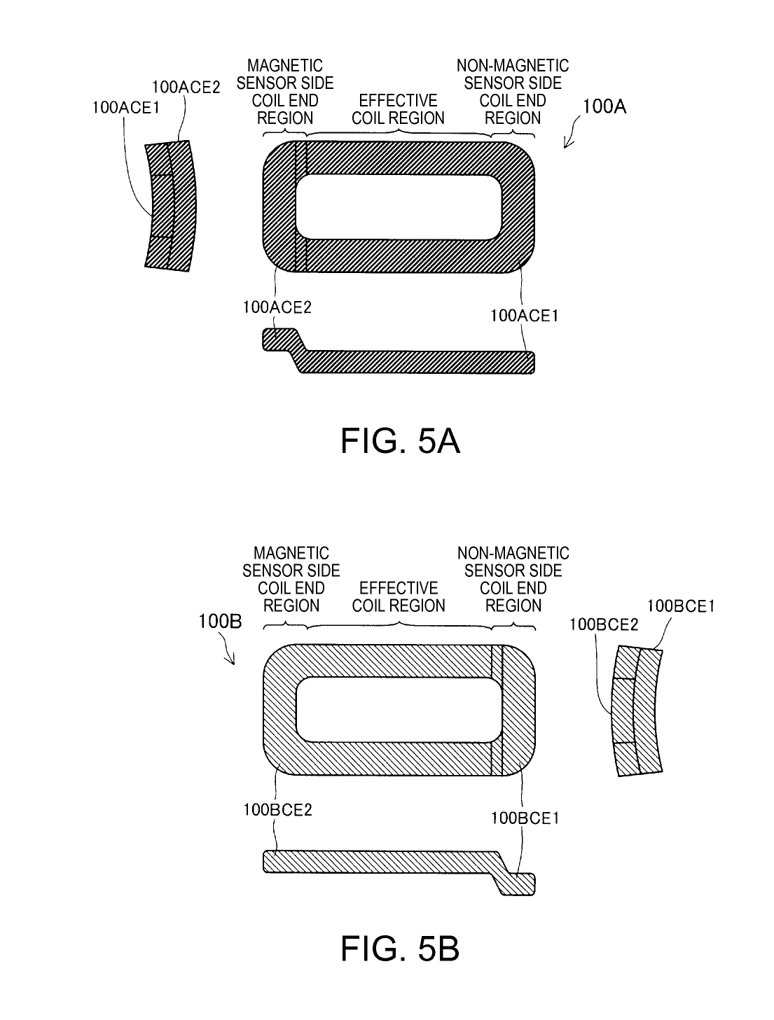

FIGS. 5A and 5B are explanatory diagrams for explaining the process for forming the electromagnetic coil. FIG. 5A shows a plan view, a front view, and a left side view of the electromagnetic coil 100A viewed from the winding surface side. FIG. 5B shows a plan view, a front view, and a right side view of the electromagnetic coil 100B viewed from the winding surface side. In steps shown in the figures, concerning the electromagnetic coil 100A, as shown in FIG. 5A, a magnetic sensor side coil end region 100ACE2 is bent to the outer circumferential side of the cylindrical region. Concerning the electromagnetic coil 100B, as shown in FIG. 5B, a non-magnetic sensor side coil end region 100BCE1 is bent to the inner circumferential side of the cylindrical region. In the steps shown in FIGS. 5A and 5B may be performed simultaneously with the step shown in FIG. 4C. In other words, the magnetic sensor side coil end region may be bent to the outer circumferential side of the cylindrical region simultaneously with the bending of the electromagnetic coil 100A along the cylindrical region. Concerning the electromagnetic coil 100B, the non-magnetic sensor side coil end region may be bent to the inner circumferential side of the cylindrical region simultaneously with the bending of the electromagnetic coil 100B along the cylindrical region.

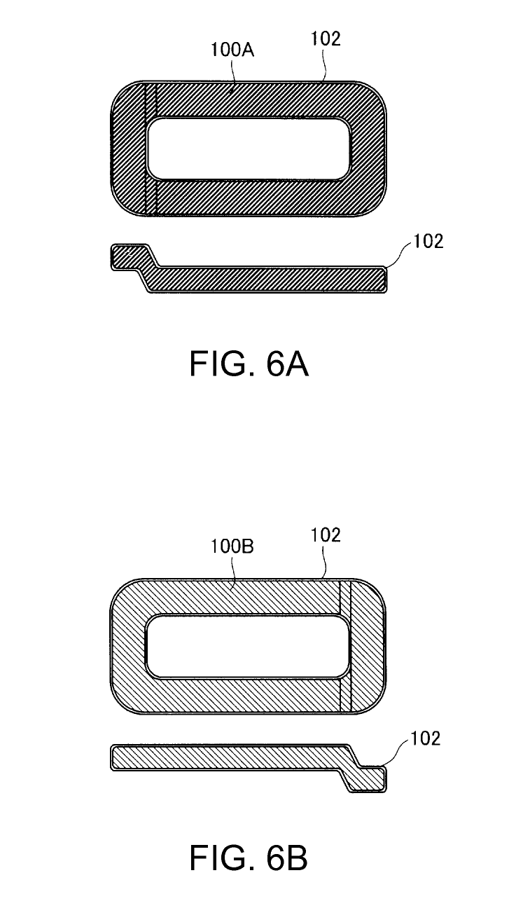

FIGS. 6A and 6B are explanatory diagrams showing the process for forming the electromagnetic coil. In steps shown in FIGS. 6A and 6B, an insulating film 102 is formed on the surfaces of the electromagnetic coils 100A and 100B. The electromagnetic coil wire rod 101 for forming the electromagnetic coils 100A and 100B include insulating coating (not shown in the figures). In the steps shown in FIG. 4C or FIGS. 5A and 5B, the electromagnetic coils 100A and 100B are compressed while being heated. Therefore, the insulating coating becomes thin and the withstanding pressure of the electromagnetic coil 100A or the electromagnetic coil 100B decreases. Therefore, the withstanding pressure of the electromagnetic coils 100A and 100B is improved by forming the insulating film 102 on the surfaces of the electromagnetic coils 100A and 100B. Since the electric resistance of the wire of the electromagnetic coil 100A or the electromagnetic coil 100B is extremely small, a voltage drop in every one turn is extremely small. Therefore, the voltage of the wire in every turn is substantially the same voltage. Even if the withstanding pressure between wires that form turns drops, no problem occurs. Therefore, it is desirable to reduce the thickness of coating of the electromagnetic coil wire rod 101 and improve a space factor. Further, it is desirable to improve the withstanding pressure of the surfaces of the electromagnetic coils 100A and 100B by providing the insulating film 102 on the surfaces of the electromagnetic coils 100A and 100B.

The coreless motor 10 is generally assembled in a procedure explained below. First, as shown in FIG. 1A, the rotor 20 is assembled such that one bearing 240 of the rotor 20 is attached to a first casing portion 110a. Subsequently, a second casing portion 110b, in the inner circumference of which the electromagnetic coils 100A and 100B and the coil back yoke 115 are arranged, is assembled to the first casing portion 110a. A third casing portion 110c is assembled to the second casing portion 110b such that the other bearing 240 attached to the rotor 20 is attached to the third casing portion 110c. Consequently, the coreless motor 10 is assembled.

As explained above, the electromagnetic coils 100A and 100B according to this embodiment are α-wound coils that can be easily subjected to the bending molding to be accurately adapted to the shape along the cylindrical surface. Therefore, it is possible to accurately arrange the plural electromagnetic coils 100A and 100B along the cylindrical surface and improve the efficiency of the coreless motor 10. Since the two coil bundles in the effective coil region of one electromagnetic coil 100B (100A) are fit in between the two coil bundles in the effective coil region of the other electromagnetic coil 100A (100B), it is possible to improve a space factor of the electromagnetic coils and improve the efficiency of the coreless motor 10.

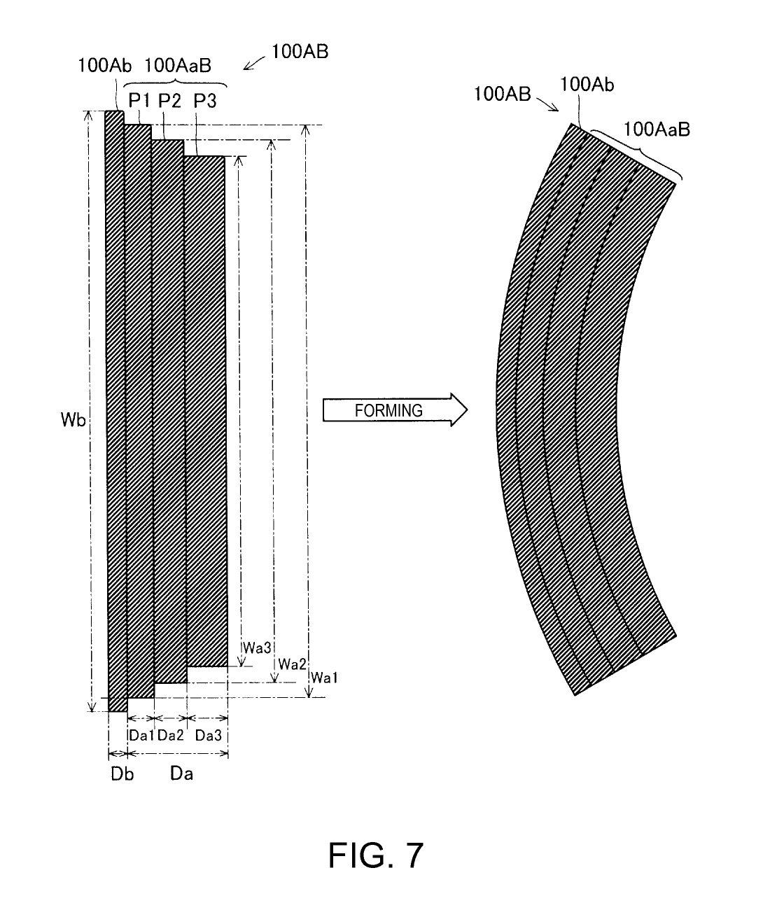

FIG. 7 is an explanatory diagram showing a modification of the electromagnetic coil. FIG. 7 shows an electromagnetic coil 100AB, which is a modification of the electromagnetic coil 100A. The electromagnetic coil 100AB can be applied as a modification of the electromagnetic coil 100B as well. As shown in FIG. 7, in the electromagnetic coil 100AB according to the modification, a coil portion 100AaB on the inner circumferential side of the cylinder during the forming (the bending molding) is divided into plural coil regions from the outer circumferential side. The winding widths of the coil regions are formed to decrease according to a curvature in order from the outer circumferential side. Specifically, the coil portion 100AaB on the inner circumferential side is divided into three coil regions P1, P2, and P3. Winding widths Wa1, Wa2, and Wa3 of the respective coil regions P1, P2, and P3 are set to decrease in order. Winding thickness Da1, Da2, and Da3 of the respective coil regions P1, P2, and P3 are set to be Da1<Da2<Da3.

When the coil portion 100AaB on the inner circumferential side is formed by plural winding layers along the winding thickness direction, as in the case of the place between the coil portion on the outer circumferential side and the coil portion on the inner circumferential side, a relative shift is sometimes conspicuous in one or more places in boundaries among the winding layers. In such a case, if the configuration like the electromagnetic coil 100AB according to the modification is adopted, it is possible to prevent accurate bending molding from becoming difficult because of a relative shift that occurs in the coil portion 100AaB. In the explanation of the electromagnetic coil 100AB according to the modification explained above, the coil portion 100AaB is divided into the three coil regions P1, P2, and P3. However, the number of divisions is an example and is not limited to three. The thicknesses Da1, Da2, and Da3 of the coil regions P1, P2, and P3 are set as Da1<Da2<Da3. However, the thicknesses are an example and are not limited to Da1<Da2<Da3. Specifically, when the bending molding is performed, the number of coil regions and the winding widths and the winding thicknesses of the coil regions only have to be set such that the bending molding can be accurately performed even if a shift occurs in the coil portion on the inner circumferential side. In the explanation of the electromagnetic coil 100AB according to the modification, the coil portion 100AaB on the inner circumferential side is divided into the plural coil regions. However, the coil portion 100Ab on the outer circumferential side may be divided into plural coil regions to set the winding widths and the winding thicknesses of the respective coil regions.

### Second Embodiment

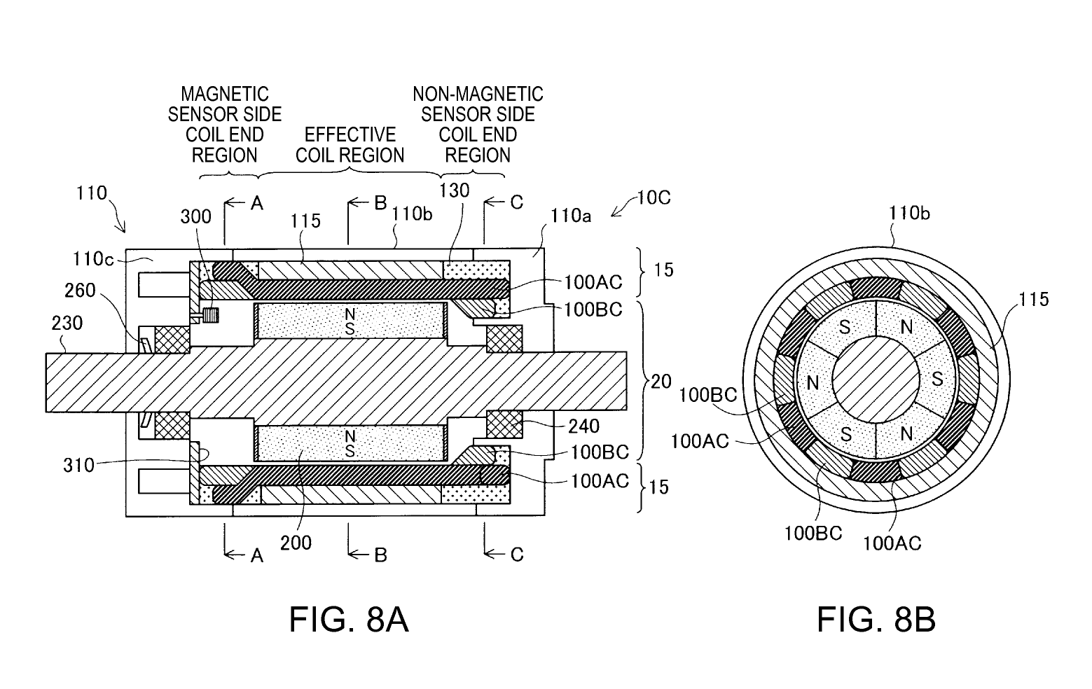

FIGS. 8A and 8B are explanatory diagrams showing a coreless motor according to a second embodiment. FIG. 8A schematically shows a diagram of a schematic cross section of a coreless motor 10C taken along a cutting line parallel to the rotating shaft 230 and viewed from a direction perpendicular to the cross section. FIG. 8B schematically shows a diagram of a schematic cross section of the coreless motor 10C taken along a cutting line (B-B in FIG. 8A) perpendicular to the rotating shaft 230 and viewed from the direction perpendicular to the cross section. The coreless motor 10C according to the second embodiment basically has the same structure as the coreless motor 10 according to the first embodiment except differences explained below. Compared with the first embodiment, in the second embodiment, as shown in FIG. 8B, the number of electromagnetic coils 100AC and 100BC is a half. According to this difference, the size of one pole of the electromagnetic coils 100AC and 100BC according to the second embodiment is larger than the size of one pole of the electromagnetic coils 100A and 100B according to the first embodiment.

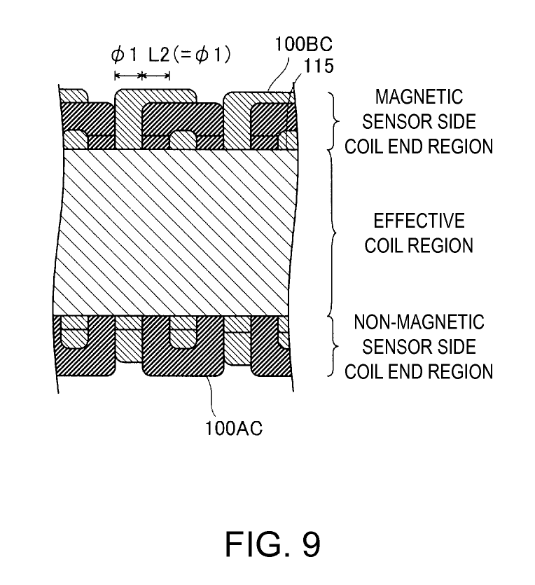

FIG. 9 is an explanatory diagram showing an arrangement state of the electromagnetic coils 100AC and 100BC. FIG. 9 is a plan view of the electromagnetic coils 100AC and 100BC viewed from a coil back yoke side. In the first embodiment, as shown in FIG. 3A, the coil bundles in the effective coil region of the two electromagnetic cols 100B are fit in between the two coil bundles in the effective coil region of the electromagnetic coil 100A. Similarly, the coil bundles in the effective coil region of the two electromagnetic coils 100A are fit in between the two coil bundles in the effective coil region of the electromagnetic coil 100B. On the other hand, in the second embodiment, as shown in FIG. 9A, a coil bundle in an effective coil region of one electromagnetic coil 100BC is fit between two coil bundles in an effective coil region of the electromagnetic coil 100AC. Similarly, a coil bundle in the effective coil region of one electromagnetic coil 100AC is fit in between two coil bundles in the effective coil region of the electromagnetic coil 100BC. As a result, whereas the electromagnetic coils in the same phase are partially in contact with each other in the first embodiment, the electromagnetic coils in the same phase are not in contact with each other in the second embodiment. According to this difference, whereas, in the first embodiment, as shown in FIG. 3A, the thickness φ1 of the coil bundles in effective coil region of the electromagnetic coils 100A and 100B is about the half size of the space L2 of the coil bundles in the effective coil region, in the second embodiment, as shown in FIG. 9, the thickness φ1 of the coil bundles in the effective coil region of the electromagnetic coils 100AC and 100BC is substantially the same size as the space L2 of the coil bundles in the effective coil region.

As explained above, the electromagnetic coils 100A and 100B according to the first embodiment and the electromagnetic coils 100AC and 100BC according to the second embodiment are different in a winding method and a combining method of the electromagnetic coils. According to this difference, specifically, whereas, in the first embodiment, as shown in FIG. 1B, the electromagnetic coils in the same phase are partially in contact with each other, in the second embodiment, as shown in FIG. 8B and FIG. 9, the part where the electromagnetic coils in the same phase are in contact with each other is eliminated. Consequently, a useless space is reduced to further improve a space factor of the electromagnetic coils than in the first embodiment.

A process for forming the electromagnetic coils 100AC and 100BC according to the second embodiment is the same as the process for forming the electromagnetic coils 100A and 100B according to the first embodiment (FIGS. 4A to 4C to FIGS. 6A and 6B) except that the winding method and the combining method of the electromagnetic coil are different as explained above.

In this embodiment, as in the first embodiment, the electromagnetic coils 100AC and 100BC are α-wound coils that can be easily subjected to bending molding to be accurately adapted to the shape along a cylindrical surface. Therefore, it is possible to accurately arrange the plural electromagnetic coils 100AC and 100BC along the cylindrical surface and improve the efficiency of the coreless motor 10C. Since the one coil bundle in the effective coil region of one electromagnetic coil 100BC (100AC) is fit in between the two coil bundles in the effective coil region of the other electromagnetic coil 100AC (100BC), it is possible to further improve a space factor of the electromagnetic coils and improve the efficiency of the coreless motor 10C than in the first embodiment.

### Third Embodiment

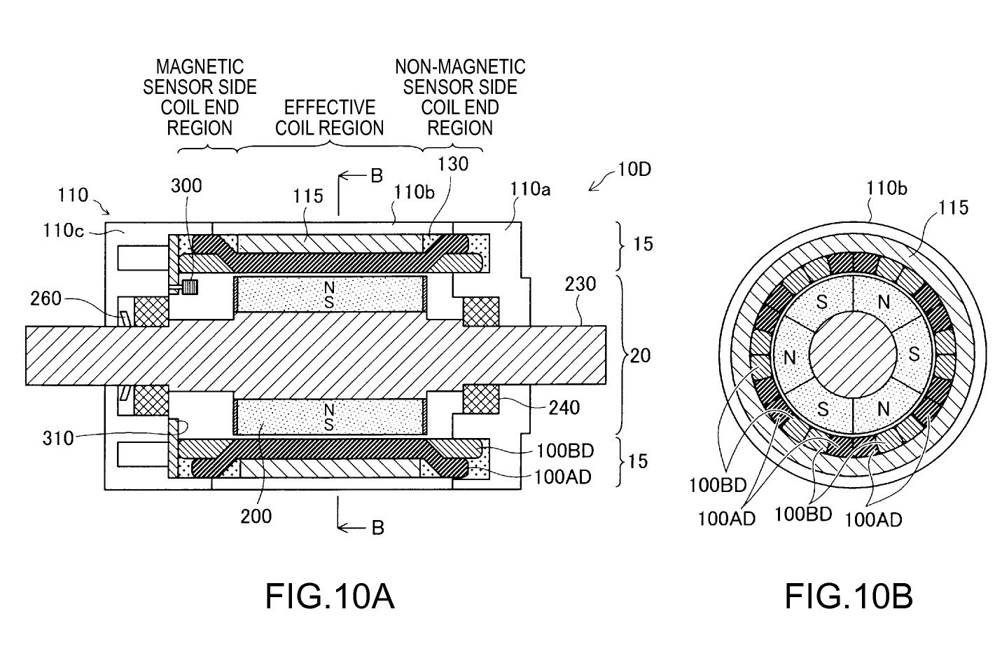

FIGS. 10A and 10B are explanatory diagrams showing a coreless motor according to a third embodiment. FIG. 10A schematically shows a diagram of a schematic cross section of a coreless motor 10D taken along a cutting line parallel to the rotating shaft 230 and viewed from a direction perpendicular to the cross section. FIG. 10B schematically shows a diagram of a schematic cross section of the coreless motor 10D taken along a cutting line (B-B in FIG. 10A) perpendicular to the rotating shaft 230 and viewed from a direction perpendicular to the cross section. The coreless motor 10D according to the third embodiment is basically the same as the coreless motor 10 according to the first embodiment except that coil end regions on both sides of an electromagnetic coil 100AD are bent from a cylindrical region where the electromagnetic coil 100AD is arranged to the outer circumferential side and coil end regions on both sides of an electromagnetic coil 100BD are not bent. A configuration in which the coil end regions on both the sides of the electromagnetic coil 100BC are bent and the coil end regions of the electromagnetic coil 100AD are not bent may be adopted.

In the third embodiment, as in the first and second embodiments, the electromagnetic coils 100AD and 100BD are α-wound coils that can be easily subjected to bending molding to be accurately adapted to the shape along a cylindrical surface. Therefore, it is possible to accurately arrange the plural electromagnetic coils 100AD and 100BD along the cylindrical surface and improve the efficiency of the coreless motor 10D. Since two coil bundles in an effective coil region of one electromagnetic coil 100BD (100AD) are fit in between two coil bundles in an effective coil region of the other electromagnetic coil 100AD (100BD), it is possible to improve a space factor of the electromagnetic coils and improve the efficiency of the coreless motor 10D.

### Fourth Embodiment

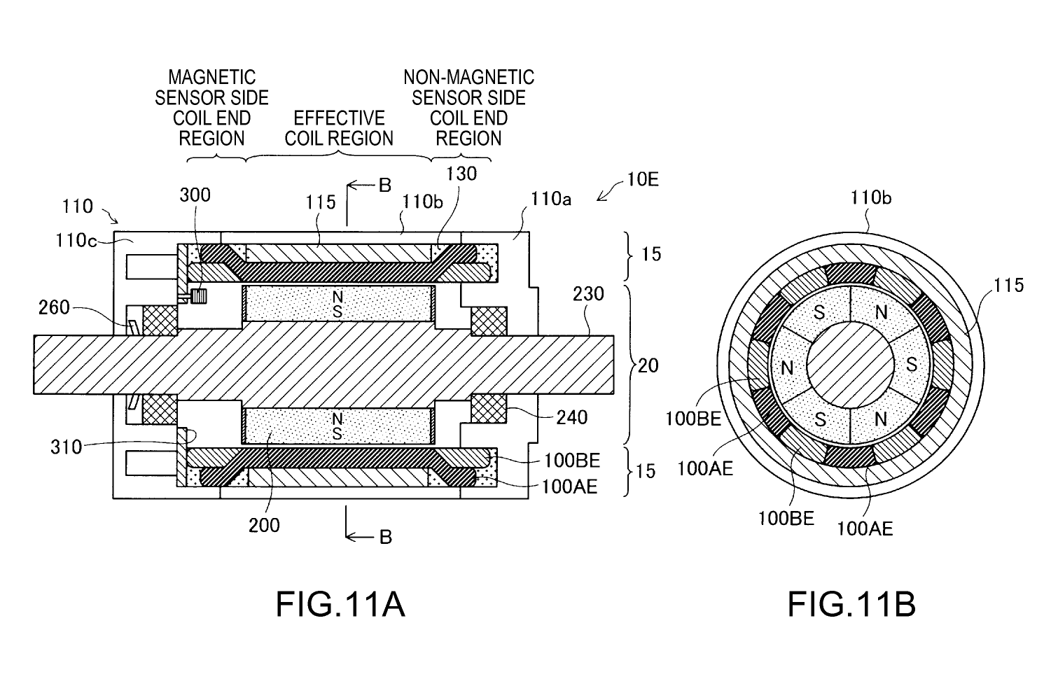

FIGS. 11A and 11B are explanatory diagrams showing a coreless motor according to a fourth embodiment. FIG. 11A schematically shows a diagram of a schematic cross section of a coreless motor 10E taken along a cutting line parallel to the rotating shaft 230 and viewed from a direction perpendicular to the cross section. FIG. 11B schematically shows a diagram of a schematic cross section of the coreless motor 10E taken along a cutting line (B-B in FIG. 11A) perpendicular to the rotating shaft 230 and viewed from a direction perpendicular to the cross section. The coreless motor 10E according to the fourth embodiment is basically the same as the coreless motor 10C according to the second embodiment except that, as in the third embodiment, coil end regions on both sides of an electromagnetic coil 100AE are bent from a cylindrical region where the electromagnetic coil 100AE is arranged to the outer circumferential side and coil end regions on both sides of an electromagnetic coil 100BE are not bent. A configuration in which the coil end regions on both the sides of the electromagnetic coil 100BE are bent and the coil end regions of the electromagnetic coil 100AE are not bent may be adopted.

In the fourth embodiment, as in the first to third embodiments, the electromagnetic coils 100AE and 100BE are α-wound coils that can be easily subjected to bending molding to be accurately adapted to the shape along a cylindrical surface. Therefore, it is possible to accurately arrange the plural electromagnetic coils 100AE and 100BE along the cylindrical surface and improve the efficiency of the coreless motor 10E. The electromagnetic coils 100AE and 100BE are α-wound coils that can be easily subjected to forming. Therefore, it is possible to accurately arrange the plural electromagnetic coils 100AE and 100BE in a cylindrical region and improve the efficiency of the coreless motor 10E. Since one coil bundle in an effective coil region of one electromagnetic coil 100BE (100AE) is fit in between two coil bundles in an effective coil region of the other electromagnetic coil 100AE (100BE), it is possible to further improve a space factor of the electromagnetic coils and improve the efficiency of the coreless motor 10E than in the third embodiment.

### Fifth Embodiment

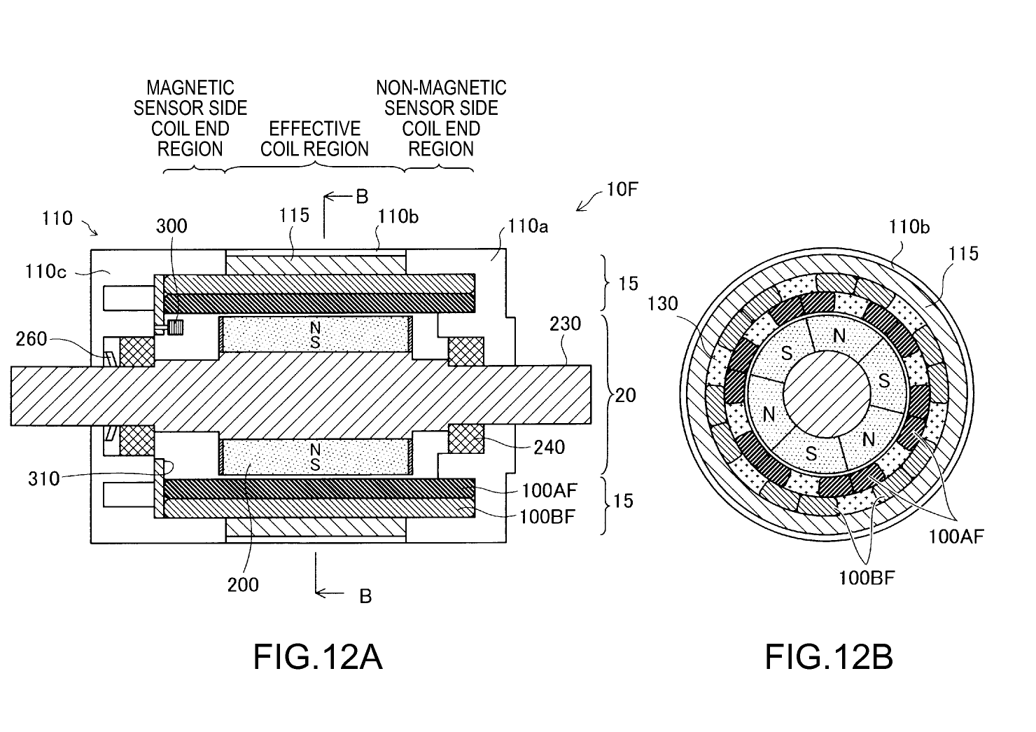

FIGS. 12A and 12B are explanatory diagrams showing a coreless motor according to a fifth embodiment. FIG. 12A schematically shows a diagram of a schematic cross section of a coreless motor 10F taken along a cutting line parallel to the rotating shaft 230 and viewed from a direction perpendicular to the cross section. FIG. 12B schematically shows a diagram of a schematic cross section of the coreless motor 10F taken along a cutting line (B-B in FIG. 12A) perpendicular to the rotating shaft 230 and viewed from a direction perpendicular to the cross section. In the coreless motor 10F according to the fifth embodiment, unlike the first to fourth embodiments in which the electromagnetic coils 100 are arranged in the cylindrical region along the same cylindrical surface, one electromagnetic coil 100AF is arranged in a cylindrical region along a cylindrical surface along the outer circumference of the permanent magnet 200, the other electromagnetic coil 100BF is arranged in a cylindrical region along a cylindrical surface of the outer circumference of the electromagnetic coil 100AF, and the electromagnetic coils 100AF and 100BF are molded with the resin 130. Coil end regions of the electromagnetic coils 100AF and 100BF are not bent. The coreless motor 10F according to the fifth embodiment is the same as the coreless motors according to the first to fourth embodiments except these differences. The cylindrical region where the electromagnetic coil 100AF is arranged and the cylindrical region where the electromagnetic coil 100BF is arranged may be opposite.

In the fifth embodiment, as in the first to fourth embodiments, the electromagnetic coils 100AF and 100BF are α-wound coils that can be easily subjected to bending molding to be accurately adapted to the shape along the cylindrical surface. Therefore, it is possible to accurately arrange the plural electromagnetic coils 100AF and 100BF along the cylindrical surface and improve the efficiency of the coreless motor 10F.

A coreless motor, which is an electric motor having a configuration of the invention explained in the embodiments, can be applied as a driving device for an electric mobile body, an electric mobile robot, or a medical apparatus as explained below.

### Sixth Embodiment

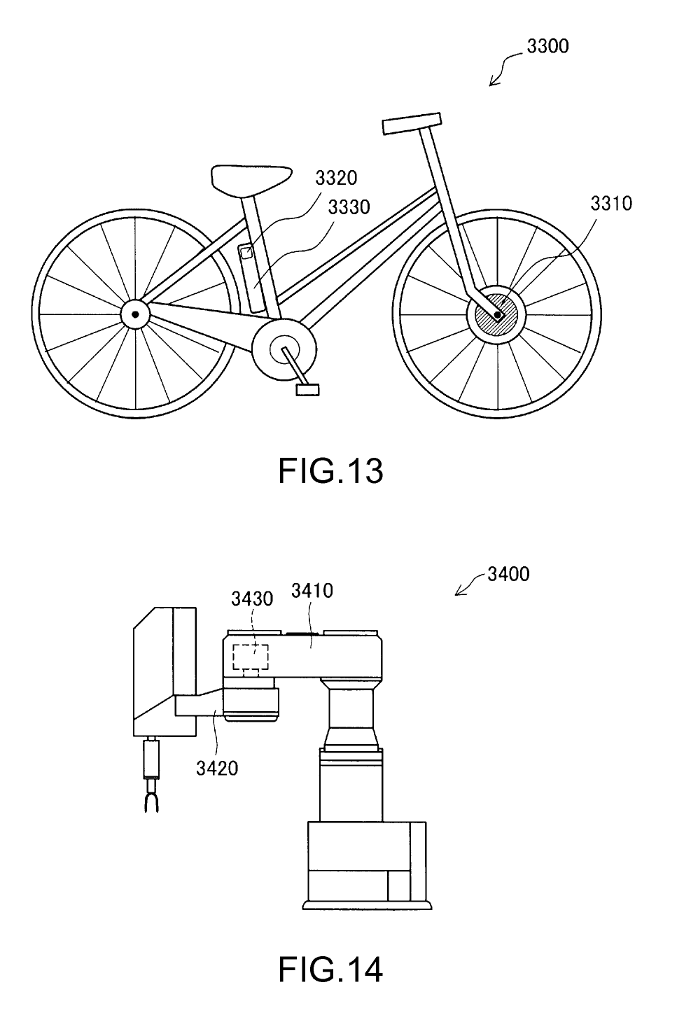

FIG. 13 is an explanatory diagram showing an electric bicycle (an electrically assisted bicycle), which is an example of a mobile body in which a coreless motor having a configuration of the invention is used. In a bicycle 3300, a motor 3310 is provided in the front wheel and a control circuit 3320 and a rechargeable battery 3330 are provided in a frame under the saddle. The motor 3310 drives the front wheel using electric power from the rechargeable battery 3330 to thereby assist traveling of the bicycle 3300. During braking, electric power regenerated by the motor 3310 is charged in the rechargeable battery 3330. The control circuit 3320 is a circuit that controls the driving and the regeneration of the motor 3310. As the motor 3310, the coreless motors explained above can be used.

### Seventh Embodiment

FIG. 14 is an explanatory diagram showing an example of a robot in which a coreless motor having a configuration of the invention is used. A robot 3400 includes first and second arms 3410 and 3420 and a motor 3430. The motor 3430 is used in horizontally rotating the second arm 3420 functioning as a driven member. As the motor 3430, the coreless motors explained above can be used.

### Eighth Embodiment

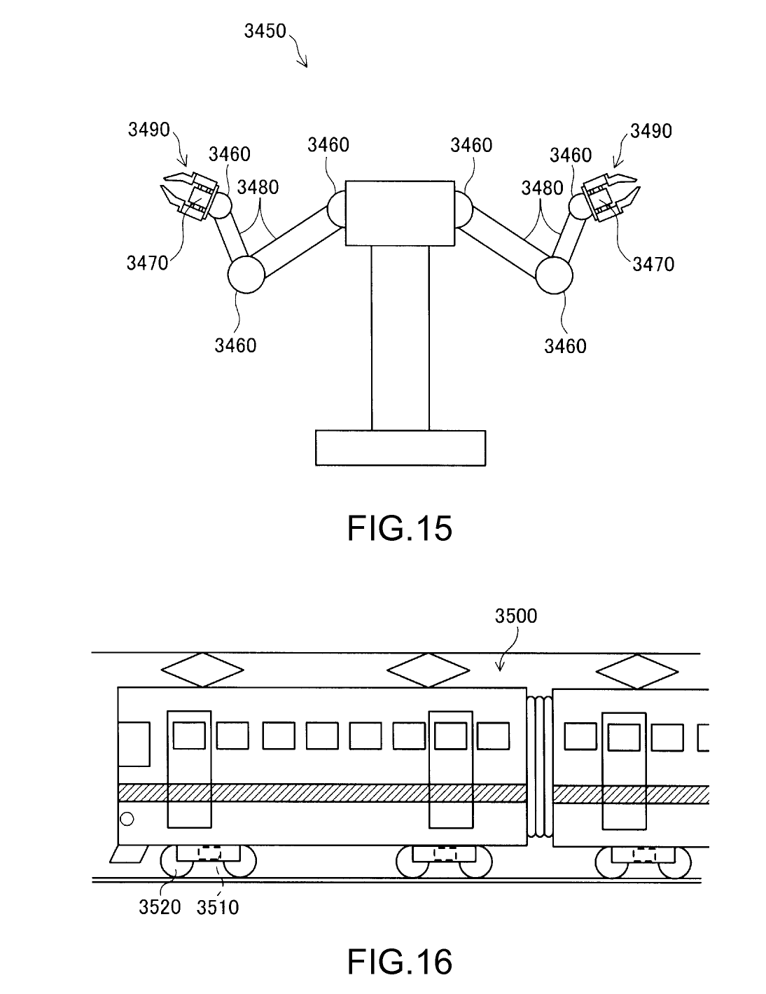

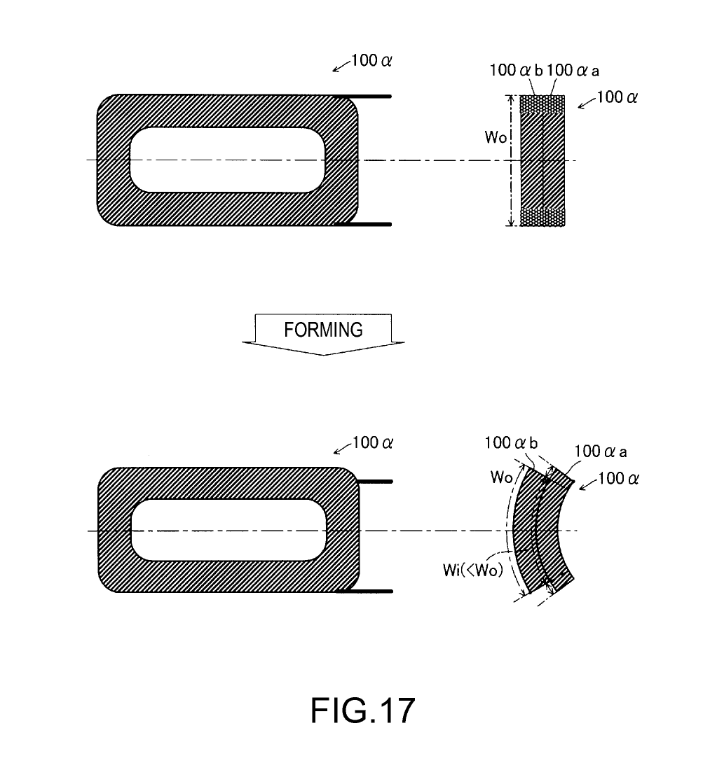

FIG. 15 is an explanatory diagram showing an example of a double-arm 7-axis robot in which a coreless motor having a configuration of the invention is used. A double-arm 7-axis robot 3450 includes joint motors 3460, grip section motors 3470, arms 3480, and gripping sections 3490. The joint motors 3460 are arranged in positions equivalent to the shoulder joints, the elbow joints and the wrist joints. The joint motors 3460 include two motors for each of the joints in order to cause the arms 3480 and the gripping sections 3490 to three-dimensionally operate. The grip section motors 3470 open and close the gripping sections 3490 to cause the gripping sections 3490 to grip objects. In the double-arm 7-axis robot 3450, as the joint motors 3460 or the grip section motors 3470, the coreless motors explained above can be used.

### Ninth Embodiment

FIG. 16 is an explanatory diagram showing a railway vehicle in which a coreless motor having a configuration of the invention is used. A railway vehicle 3500 includes an electric motor 3510 and a wheel 3520. The electric motor 3510 drives the wheel 3520. The electric motor 3510 is used as a generator during braking of the railway vehicle 3500 to regenerate electric power. As the electric motor 3510, the coreless motors can be used.

### Modifications

Among the components in the embodiments, elements other than claimed elements in the appended independent claims are additional elements and can be omitted as appropriate. The invention is not limited to the examples and the embodiments explained above. The invention can be carried out in various forms without departing from the spirit of the invention.

### Modification 1

In the first to fifth embodiments, the coreless motors in the case of the two-phase electromagnetic coils are explained as examples. However, the invention is not limited to this and may be a coreless motor including electromagnetic coils in three or more plural phases.

### Modification 2

In the embodiments, the coreless motors having the characteristics of the invention are explained as the examples. However, the invention is not limited to the coreless motors functioning as electric motors and can also be applied to a generator.

The present application claims priority based on Japanese Patent Application No. 2011-196716 filed on Sep. 9, 2011, the disclosure of which is hereby incorporated by reference in its entirety.

What is claimed is:

1. An air-core electromagnetic coil arranged along a cylindrical surface of a first member or a second member having a cylindrical shape in a coreless electromechanical device in which the first member and the second member relatively rotate,
the electromagnetic coil being an α-wound coil formed by winding ends on both sides of a predetermined intermediate position of a wire rod from air-core end edges of both the ends toward an outer circumferential side to form two coil portions and superimposing the formed two coil portions to be opposed to each other, wherein
when the electromagnetic coil is subjected to bending molding to be adapted to a shape along the cylindrical surface on which the electromagnetic coil is arranged, circumferential length of a bent-molded shape along a circumferential direction of the cylindrical surface of a first coil portion arranged on an inner circumferential side is set to be smaller than circumferential length of a bent-molded shape along a circumferential direction of the cylindrical surface of a second coil portion arranged on an outer circumferential side.

2. The electromagnetic coil according to claim 1, wherein thickness of the second coil portion along a superimposing direction of the two coil portions is smaller than thickness of the first coil portion.

3. The electromagnetic coil according to claim 2, wherein
the first coil portion is divided into a plurality of first coil regions along the superimposing direction of the two coil portions, and
circumferential length of a bent-molded shape along the circumferential direction of the cylindrical surface of the first coil regions decreases in order further away from a superimposed surface of the two coil portions.

4. The electromagnetic coil according to claim 3, wherein
the second coil portion is divided into a plurality of second coil regions along the superimposing direction, and
circumferential length of a bent-molded shape along the circumferential direction of the cylindrical surface of the second coil regions increases in order further away from a superimposed surface of the two coil portions.

5. A coreless electromechanical device in which first and second members having a cylindrical shape relatively rotate, the coreless electromechanical device comprising:
a permanent magnet arranged in the first member; and
a plurality of air-core electromagnetic coils arranged in the second member, wherein
the electromagnetic coil is the electromagnetic coil according to claim 4.

6. A mobile body comprising the coreless electromechanical device according to claim 5.

7. A robot comprising the coreless electromechanical device according to claim 5.

8. A method of manufacturing an air-core electromagnetic coil arranged along a cylindrical surface of a first member or a second member having a cylindrical shape in a coreless electromechanical device in which the first member and the second member relatively rotate, the method comprising:
winding ends on both sides of a predetermined intermediate position of a wire rod from air-core end edges of both the ends toward an outer circumferential side to form two coil portions, when the electromagnetic coil is subjected to bending molding to be adapted to a shape along the cylindrical surface on which the electromagnetic coil is arranged in the coreless electromechanical device, circumferential length of a bent-molded shape along a circumferential direction of the cylindrical surface of a first coil portion arranged on the inner circumferential side being set to be smaller than circumferential length of a bent-molded shape along a circumferential direction of the cylindrical surface of a second coil portion arranged on an outer circumferential side;
superimposing the formed two coil portions to be opposed to each other; and
subjecting the superimposed two coil portions to the bending molding to be adapted to the shape along the cylindrical surface on which the electromagnetic coil is arranged in the coreless electromechanical device.
